(19) United States
(12) Patent Application Publication
(10) Pub. No.: US 2015/0169047 A1
(43) Pub. Date: Jun. 18, 2015

(54) METHOD AND APPARATUS FOR CAUSATION OF CAPTURE OF VISUAL INFORMATION INDICATIVE OF A PART OF AN ENVIRONMENT

(71) Applicant: Nokia Corporation, Espoo (FI)

(72) Inventor: Erika Reponen, Tampere (FI)

(21) Appl. No.: 14/107,695

(22) Filed: Dec. 16, 2013

(51) Int. Cl. G06F 3/01

(52) U.S. Cl. CPC G06F 3/013

(57) ABSTRACT

A method comprising determining that a user's attention is directed away from at least part of an environment surrounding the user, the part of the environment being within a capture region of a camera module, causing capture of visual information indicative of the part of the environment based, at least in part, on the determination that the user's attention is directed away from the part of the environment, causing storage of the visual information as at least part of a video media item, determining that the user's attention is directed towards the part of the environment, and causing termination of capture of the visual information based, at least in part, on the determination that the user's attention is directed towards the part of the environment is disclosed.

### TECHNICAL FIELD

The present application relates generally to causation of capture of visual information indicative of a part of an environment.

### BACKGROUND

As electronic apparatuses become increasingly pervasive in our society, it may be desirable to allow for utilization of such electronic apparatuses in a manner which facilitates perception of real environments, situational awareness, and/or the like. For example, a user of an electronic apparatus may desire to be aware of and/or to perceive visual information that the user may not initially be paying attention to, may desire to perceive visual information depicting at least a part of a real environment surrounding the user, and/or the like, in a manner that is intuitive and convenient.

### SUMMARY

Various aspects of examples of the invention are set out in the claims.

One or more embodiments may provide an apparatus, a computer readable medium, a non-transitory computer readable medium, a computer program product, and a method for determining that a user's attention is directed away from at least part of an environment surrounding the user, the part of the environment being within a capture region of a camera module, causing capture of visual information indicative of the part of the environment based, at least in part, on the determination that the user's attention is directed away from the part of the environment, causing storage of the visual information as at least part of a video media item, determining that the user's attention is directed towards the part of the environment, and causing termination of capture of the visual information based, at least in part, on the determination that the user's attention is directed towards the part of the environment.

One or more embodiments may provide an apparatus, a computer readable medium, a computer program product, and a non-transitory computer readable medium having means for determining that a user's attention is directed away from at least part of an environment surrounding the user, the part of the environment being within a capture region of a camera module, means for causing capture of visual information indicative of the part of the environment based, at least in part, on the determination that the user's attention is directed away from the part of the environment, means for causing storage of the visual information as at least part of a video media item, means for determining that the user's attention is directed towards the part of the environment, and means for causing termination of capture of the visual information based, at least in part, on the determination that the user's attention is directed towards the part of the environment.

In at least one example embodiment, the determination that the user's attention is directed away from the part of the environment comprises determination of a gaze position of the user, and determination that the gaze position fails to correspond with the part of the environment.

In at least one example embodiment, the determination that the gaze position fails to correspond with the part of the environment is based, at least in part, on the gaze position corresponding with a display.

In at least one example embodiment, the display is a head mounted display.

In at least one example embodiment, the camera module is comprised by the head mounted display.

In at least one example embodiment, the camera module is positioned such that the capture region of the camera module at least partially corresponds with a field of view of the user.

In at least one example embodiment, the gaze position comprises a gaze depth, and wherein the determination that the gaze position fails to correspond with the part of the environment comprises determination that the gaze depth corresponds with the display.

In at least one example embodiment, the determination that the user's attention is directed away from the part of the environment further comprises determination that the gaze position corresponds with information being displayed by the display.

In at least one example embodiment, the determination that the gaze position fails to correspond with the part of the environment is based, at least in part, on the gaze position corresponding with a different part of the environment.

In at least one example embodiment, the different part of the environment is oriented with respect to the user such that the user's attention being directed toward the different part of the environment precludes the user's attention being directed toward the part of the environment.

In at least one example embodiment, the determination that the user's attention is directed away from the part of the environment comprises determination of a user orientation, and determination that the user orientation is inconsistent with the part of the environment being within a field of view of the user.

One or more example embodiments further perform determination that a capture non-attention duration threshold has been satisfied, and wherein the causation of capture of the visual information is further based, at least in part, on the determination that the capture non-attention duration threshold has been satisfied.

In at least one example embodiment, the capture non-attention duration threshold is an amount of time that the user's attention has been directed away from the part of the environment after which it may be desirable to cause capture of the visual information indicative of the part of the environment.

In at least one example embodiment, the determination that a non-attention duration threshold has been satisfied comprises determination that an amount of time greater than or equal to the non-attention duration threshold has elapsed since the determination that the user's attention is directed away from the part of the environment.

One or more example embodiments further perform determination that a storage non-attention duration threshold has been satisfied, and wherein the causation of storage of the visual information is further based, at least in part, on the determination that the storage non-attention duration threshold has been satisfied.

In at least one example embodiment, the storage non-attention duration threshold is an amount of time that the user's attention has been directed away from the part of the environment after which it may be desirable to cause storage of the visual information as the part of the video media item.

One or more example embodiments further perform determination that the video media item has satisfied a video media item size threshold, and causation of removal of at least part of the video media item based, at least in part, on the determination that the video media item size threshold has been satisfied.

In at least one example embodiment, the removal of the part of the video media item is a first-in-first-out removal.

In at least one example embodiment, the video media item size threshold is a temporal size of the video media item beyond which the part of the video media item is to be removed.

In at least one example embodiment, the video media item size threshold is a disk utilization size of the video media item beyond which the part of the video media item is to be removed.

One or more example embodiments further perform causation of deletion of at least part of the video media item.

In at least one example embodiment, the causation of deletion of the part of the video media item is based, at least in part, on satisfaction of a video media item deletion threshold.

In at least one example embodiment, the video media item deletion threshold is a duration after which a video media item is to be deleted.

In at least one example embodiment, the video media item deletion threshold is less than an hour.

In at least one example embodiment, the video media item deletion threshold is five minutes.

One or more example embodiments further perform receipt of information indicative of a video media item rendering input, and causation of rendering of at least part of the video media item based, at least in part, on the video media item rendering input.

One or more example embodiments further perform causation of rendering of a different video media item that is associated with the video media item based, at least in part, on the video media item rendering input.

One or more example embodiments further perform determination of an occurrence of a significant event associated with the part of the environment, and causation of rendering of an event notification based, at least in part, on the occurrence of the significant event.

In at least one example embodiment, the significant event is an event that the user may desire to be aware of.

In at least one example embodiment, the event notification comprises information indicative of the event notification such that rendering of the event notification notifies the user of the occurrence of the significant event.

### BRIEF DESCRIPTION OF THE DRAWINGS

For a more complete understanding of embodiments of the invention, reference is now made to the following descriptions taken in connection with the accompanying drawings in which:

FIG. 1 is a block diagram showing an apparatus according to an example embodiment;

FIGS. 2A-2B are diagrams illustrating see through displays according to at least one example embodiment;

FIGS. 3A-3B are diagrams illustrating capture of visual information indicative of a part of an environment according to at least one example embodiment;

FIG. 4 is a flow diagram illustrating activities associated with causing capture of visual information indicative of a part of an environment according to at least one example embodiment;

FIG. 5 is a flow diagram illustrating activities associated with causing capture of visual information indicative of a part of an environment based on satisfaction of a capture non-attention duration threshold according to at least one example embodiment;

FIG. 6 is a flow diagram illustrating activities associated with causing storage of visual information indicative of a part of an environment based on satisfaction of a storage non-attention duration threshold according to at least one example embodiment;

FIG. 7 is a flow diagram illustrating activities associated with causing removal of at least a part of a video media item based on satisfaction of a video media item size threshold according to at least one example embodiment;

FIG. 8 is a flow diagram illustrating activities associated with causing deletion of at least a part of a video media item based on satisfaction of a video media item deletion threshold according to at least one example embodiment; and

FIG. 9 is a flow diagram illustrating activities associated with causing rendering of an event notification based on occurrence of a significant event according to at least one example embodiment.

### DETAILED DESCRIPTION OF THE DRAWINGS

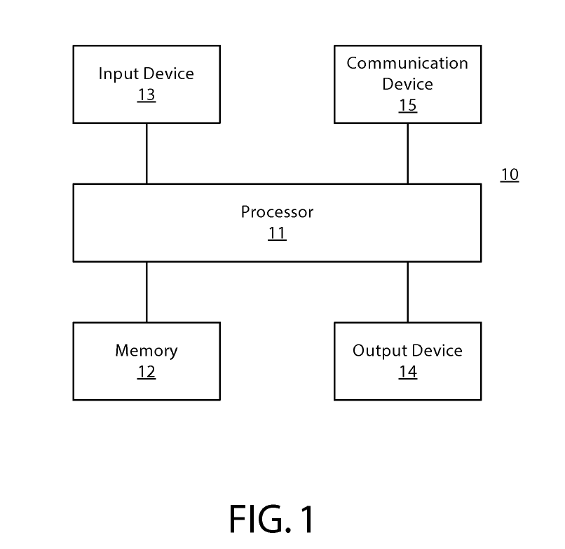

An embodiment of the invention and its potential advantages are understood by referring to FIGS. 1 through 9 of the drawings.

Some embodiments will now be described more fully hereinafter with reference to the accompanying drawings, in which some, but not all, embodiments are shown. Various embodiments of the invention may be embodied in many different forms and should not be construed as limited to the embodiments set forth herein; rather, these embodiments are provided so that this disclosure will satisfy applicable legal requirements. Like reference numerals refer to like elements throughout. As used herein, the terms “data,” “content,” “information,” and similar terms may be used interchangeably to refer to data capable of being transmitted, received and/or stored in accordance with embodiments of the present invention. Thus, use of any such terms should not be taken to limit the spirit and scope of embodiments of the present invention.

Additionally, as used herein, the term ‘circuitry’ refers to (a) hardware-only circuit implementations (e.g., implementations in analog circuitry and/or digital circuitry); (b) combinations of circuits and computer program product(s) comprising software and/or firmware instructions stored on one or more computer readable memories that work together to cause an apparatus to perform one or more functions described herein; and (c) circuits, such as, for example, a microprocessor(s) or a portion of a microprocessor(s), that require software or firmware for operation even if the software or firmware is not physically present. This definition of ‘circuitry’ applies to all uses of this term herein, including in any claims. As a further example, as used herein, the term ‘circuitry’ also includes an implementation comprising one or more processors and/or portion(s) thereof and accompanying software and/or firmware. As another example, the term ‘circuitry’ as used herein also includes, for example, a baseband integrated circuit or applications processor integrated circuit for a mobile phone or a similar integrated circuit in a server, a cellular network apparatus, other network apparatus, and/or other computing apparatus.

As defined herein, a “non-transitory computer-readable medium,” which refers to a physical medium (e.g., volatile or non-volatile memory device), can be differentiated from a “transitory computer-readable medium,” which refers to an electromagnetic signal.

FIG. 1 is a block diagram showing an apparatus, such as an electronic apparatus 10, according to at least one example embodiment. It should be understood, however, that an electronic apparatus as illustrated and hereinafter described is merely illustrative of an electronic apparatus that could benefit from embodiments of the invention and, therefore, should not be taken to limit the scope of the invention. While electronic apparatus 10 is illustrated and will be hereinafter described for purposes of example, other types of electronic apparatuses may readily employ embodiments of the invention. Electronic apparatus 10 may be a personal digital assistant (PDAs), a pager, a mobile computer, a desktop computer, a television, a gaming apparatus, a laptop computer, a tablet computer, a media player, a camera, a video recorder, a mobile phone, a wearable apparatus, a head worn apparatus, a head mounted display, a see through display, a near eye display, a wrist worn apparatus, a watch apparatus, a finger worn apparatus, a ring apparatus, a global positioning system (GPS) apparatus, an automobile, a kiosk, an electronic table, and/or any other types of electronic systems. Moreover, the apparatus of at least one example embodiment need not be the entire electronic apparatus, but may be a component or group of components of the electronic apparatus in other example embodiments. For example, the apparatus may be an integrated circuit, a set of integrated circuits, and/or the like.

Furthermore, apparatuses may readily employ embodiments of the invention regardless of their intent to provide mobility. In this regard, even though embodiments of the invention may be described in conjunction with mobile applications, it should be understood that embodiments of the invention may be utilized in conjunction with a variety of other applications, both in the mobile communications industries and outside of the mobile communications industries. For example, the apparatus may be, at least part of, a non-carryable apparatus, such as a large screen television, an electronic table, a kiosk, an automobile, and/or the like.

In at least one example embodiment, electronic apparatus 10 comprises processor 11 and memory 12. Processor 11 may be any type of processor, controller, embedded controller, processor core, and/or the like. In at least one example embodiment, processor 11 utilizes computer program code to cause an apparatus to perform one or more actions. Memory 12 may comprise volatile memory, such as volatile Random Access Memory (RAM) including a cache area for the temporary storage of data and/or other memory, for example, non-volatile memory, which may be embedded and/or may be removable. The non-volatile memory may comprise an EEPROM, flash memory and/or the like. Memory 12 may store any of a number of pieces of information, and data. The information and data may be used by the electronic apparatus 10 to implement one or more functions of the electronic apparatus 10, such as the functions described herein. In at least one example embodiment, memory 12 includes computer program code such that the memory and the computer program code are configured to, working with the processor, cause the apparatus to perform one or more actions described herein.

The electronic apparatus 10 may further comprise a communication device 15. In at least one example embodiment, communication device 15 comprises an antenna, (or multiple antennae), a wired connector, and/or the like in operable communication with a transmitter and/or a receiver. In at least one example embodiment, processor 11 provides signals to a transmitter and/or receives signals from a receiver. The signals may comprise signaling information in accordance with a communications interface standard, user speech, received data, user generated data, and/or the like. Communication device 15 may operate with one or more air interface standards, communication protocols, modulation types, and access types. By way of illustration, the electronic communication device 15 may operate in accordance with second-generation (2G) wireless communication protocols IS-136 (time division multiple access (TDMA)), Global System for Mobile communications (GSM), and IS-95 (code division multiple access (CDMA)), with third-generation (3G) wireless communication protocols, such as Universal Mobile Telecommunications System (UMTS), CDMA2000, wideband CDMA (WCDMA) and time division-synchronous CDMA (TD-SCDMA), and/or with fourth-generation (4G) wireless communication protocols, wireless networking protocols, such as 802.11, short-range wireless protocols, such as Bluetooth, and/or the like. Communication device 15 may operate in accordance with wireline protocols, such as Ethernet, digital subscriber line (DSL), asynchronous transfer mode (ATM), and/or the like.

Processor 11 may comprise means, such as circuitry, for implementing audio, video, communication, navigation, logic functions, and/or the like, as well as for implementing embodiments of the invention including, for example, one or more of the functions described herein. For example, processor 11 may comprise means, such as a digital signal processor device, a microprocessor device, various analog to digital converters, digital to analog converters, processing circuitry and other support circuits, for performing various functions including, for example, one or more of the functions described herein. The apparatus may perform control and signal processing functions of the electronic apparatus 10 among these devices according to their respective capabilities. The processor 11 thus may comprise the functionality to encode and interleave message and data prior to modulation and transmission. The processor 1 may additionally comprise an internal voice coder, and may comprise an internal data modem. Further, the processor 11 may comprise functionality to operate one or more software programs, which may be stored in memory and which may, among other things, cause the processor 11 to implement at least one embodiment including, for example, one or more of the functions described herein. For example, the processor 11 may operate a connectivity program, such as a conventional internet browser. The connectivity program may allow the electronic apparatus 10 to transmit and receive internet content, such as location-based content and/or other web page content, according to a Transmission Control Protocol (TCP), Internet Protocol (IP), User Datagram Protocol (UDP), Internet Message Access Protocol (IMAP), Post Office Protocol (POP), Simple Mail Transfer Protocol (SMTP), Wireless Application Protocol (WAP), Hypertext Transfer Protocol (HTTP), and/or the like, for example.

The electronic apparatus 10 may comprise a user interface for providing output and/or receiving input. The electronic apparatus 10 may comprise an output device 14. Output device 14 may comprise an audio output device, such as a ringer, an earphone, a speaker, and/or the like. Output device 14 may comprise a tactile output device, such as a vibration transducer, an electronically deformable surface, an electronically deformable structure, and/or the like. Output device 14 may comprise a visual output device, such as a display, a light, and/or the like. In at least one example embodiment, the apparatus causes display of information, the causation of display may comprise displaying the information on a display comprised by the apparatus, sending the information to a separate apparatus that comprises a display, and/or the like. The electronic apparatus may comprise an input device 13. Input device 13 may comprise a light sensor, a proximity sensor, a microphone, a touch sensor, a force sensor, a button, a keypad, a motion sensor, a magnetic field sensor, a camera, and/or the like. A touch sensor and a display may be characterized as a touch display. In an embodiment comprising a touch display, the touch display may be configured to receive input from a single point of contact, multiple points of contact, and/or the like. In such an embodiment, the touch display and/or the processor may determine input based, at least in part, on position, motion, speed, contact area, and/or the like. In at least one example embodiment, the apparatus receives an indication of an input. The apparatus may receive the indication from a sensor, a driver, a separate apparatus, and/or the like. The information indicative of the input may comprise information that conveys information indicative of the input, indicative of an aspect of the input indicative of occurrence of the input, and/or the like.

The electronic apparatus 10 may include any of a variety of touch displays including those that are configured to enable touch recognition by any of resistive, capacitive, infrared, strain gauge, surface wave, optical imaging, dispersive signal technology, acoustic pulse recognition or other techniques, and to then provide signals indicative of the location and other parameters associated with the touch. Additionally, the touch display may be configured to receive an indication of an input in the form of a touch event which may be defined as an actual physical contact between a selection object (e.g., a finger, stylus, pen, pencil, or other pointing device) and the touch display. Alternatively, a touch event may be defined as bringing the selection object in proximity to the touch display, hovering over a displayed object or approaching an object within a predefined distance, even though physical contact is not made with the touch display. As such, a touch input may comprise any input that is detected by a touch display including touch events that involve actual physical contact and touch events that do not involve physical contact but that are otherwise detected by the touch display, such as a result of the proximity of the selection object to the touch display. A touch display may be capable of receiving information associated with force applied to the touch screen in relation to the touch input. For example, the touch screen may differentiate between a heavy press touch input and a light press touch input. In at least one example embodiment, a display may display two-dimensional information, three-dimensional information and/or the like.

In embodiments including a keypad, the keypad may comprise numeric (for example, 0-9) keys, symbol keys (for example, #, *), alphabetic keys, and/or the like for operating the electronic apparatus 10. For example, the keypad may comprise a conventional QWERTY keypad arrangement. The keypad may also comprise various soft keys with associated functions. In addition, or alternatively, the electronic apparatus 10 may comprise an interface device such as a joystick or other user input interface.

Input device 13 may comprise a media capturing element. The media capturing element may be any means for capturing an image, video, and/or audio for storage, display or transmission. For example, in at least one example embodiment in which the media capturing element is a camera module, the camera module may comprise a digital camera which may form a digital image file from a captured image. As such, the camera module may comprise hardware, such as a lens or other optical component(s), and/or software necessary for creating a digital image file from a captured image. Alternatively, the camera module may comprise only the hardware for viewing an image, while a memory device of the electronic apparatus 10 stores instructions for execution by the processor 11 in the form of software for creating a digital image file from a captured image. In at least one example embodiment, the camera module may further comprise a processing element such as a co-processor that assists the processor 11 in processing image data and an encoder and/or decoder for compressing and/or decompressing image data. The encoder and/or decoder may encode and/or decode according to a standard format, for example, a Joint Photographic Experts Group (JPEG) standard format.

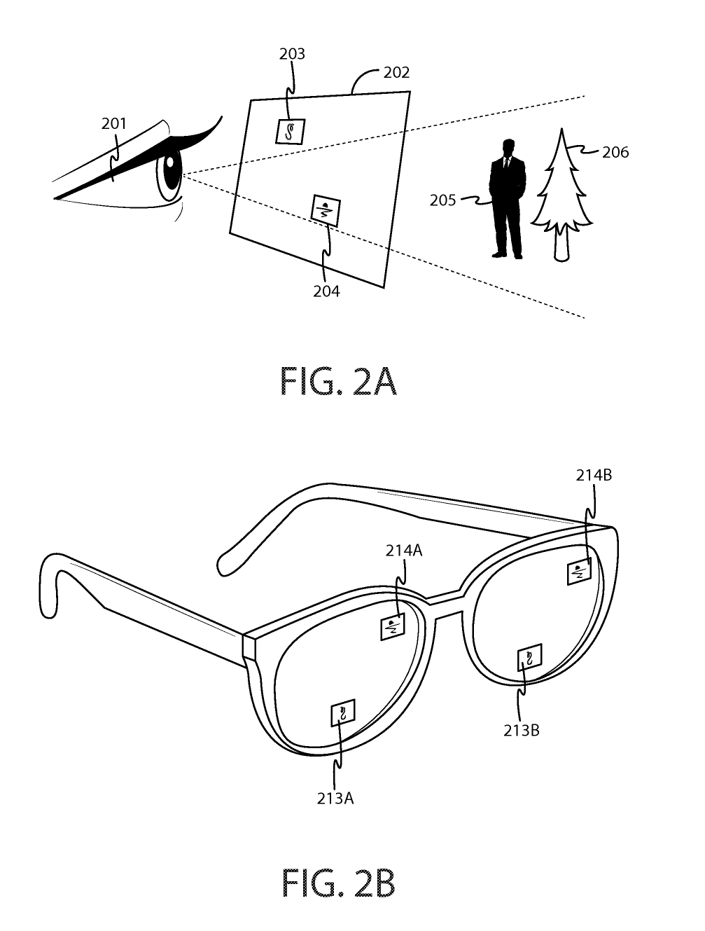

FIGS. 2A-2B are diagrams illustrating see through displays according to at least one example embodiment. The examples of FIGS. 2A-2B are merely examples and do not limit the scope of the claims. For example, configuration of the see through display may vary, relationship between the user and the see through display may vary, shape of the see through display may vary, opacity of the see through display may vary, and/or the like. In modern times, electronic apparatuses are becoming more prevalent and pervasive. Users often utilize such apparatuses for a variety of purposes. For example, a user may utilize an apparatus to view information that is displayed on a display of the apparatus, to perceive information associated with the user's surroundings on the display of the apparatus, and/or the like. In many circumstances, a user may desire to view information associated with an apparatus in a way that is noninvasive, nonintrusive, discreet, and/or the like. In such circumstances, it may be desirable for a display to be a see through display. In at least one example embodiment, a see through display is a display that presents information to a user, but through which objects on an opposite side of the display from the user may be seen. A see through display may be comprised by a window, a windshield, a visor, glasses, a head mounted display, and/or the like. In at least one example embodiment, an apparatus is a head mounted display. A head mounted display may, for example, be a display that is head mountable, a display that is coupled to an element that wearable at a location on and/or proximate to the head of a user, a display that is wearable at a location on and/or proximate to the head of a user, and/or the like.

In some circumstances, it may be desirable for a display to preclude a user from seeing objects that may be positioned beyond the display. For example, a user may prefer to have information displayed on a solid display, have information displayed against a solid background, to avoid distractions that may be associated with perception of information on a see through display, and/or the like. In at least one example embodiment, a head mounted display may comprise an opaque display. An opaque display may be a display that is not a see through display, a display through which objects on an opposite side of the display may be obscured, and/or the like.

FIG. 2A is a diagram illustrating see through display 202 according to at least one example embodiment. In at least one example embodiment, displaying information on a see through display so that the information corresponds with one or more objects viewable through the see through display is referred to as augmented reality. In the example of FIG. 2A, user 201 may perceive objects 205 and 206 through see through display 202. In at least one example embodiment, the see through display may display information to the user. For example, display 202 may display information 203 and information 204. Information 203 and information 204 may be positioned on display 202 such that the information corresponds with one or more objects viewable through see through display 202, such as object 205. In such an example, information 203 may be associated with, identify, and/or the like, object 205. For example, information 203 may indicate an identity of object 205. In at least one example embodiment, display 202 may be comprised by a head mounted display.

FIG. 2B is a diagram illustrating a see through display according to at least one example embodiment. In at least one example embodiment, a see through display is a near eye display. A near eye display may be a see through display that is positioned proximate to an eye of the user. The example of FIG. 2B illustrates glasses that comprise a near eye display in each lens. In the example of FIG. 2B, the right near eye display is displaying information 213A and 214A, and the left near eye display is displaying information 213B and 214B. In at least one example embodiment, information 213A may be associated with information 213B. For example, the content of information 213A may be identical to content of information 213B. In some circumstances, even though the content may be identical between 213A and 213B, position of information 213A on the right near eye display may vary from position of information 213B on the left near eye display. In this manner, the apparatus may vary position of information between the left near eye display and right near eye display to vary the parallax of the information perceived by the user. In this manner, the apparatus may vary the perceived depth of the information by the user.

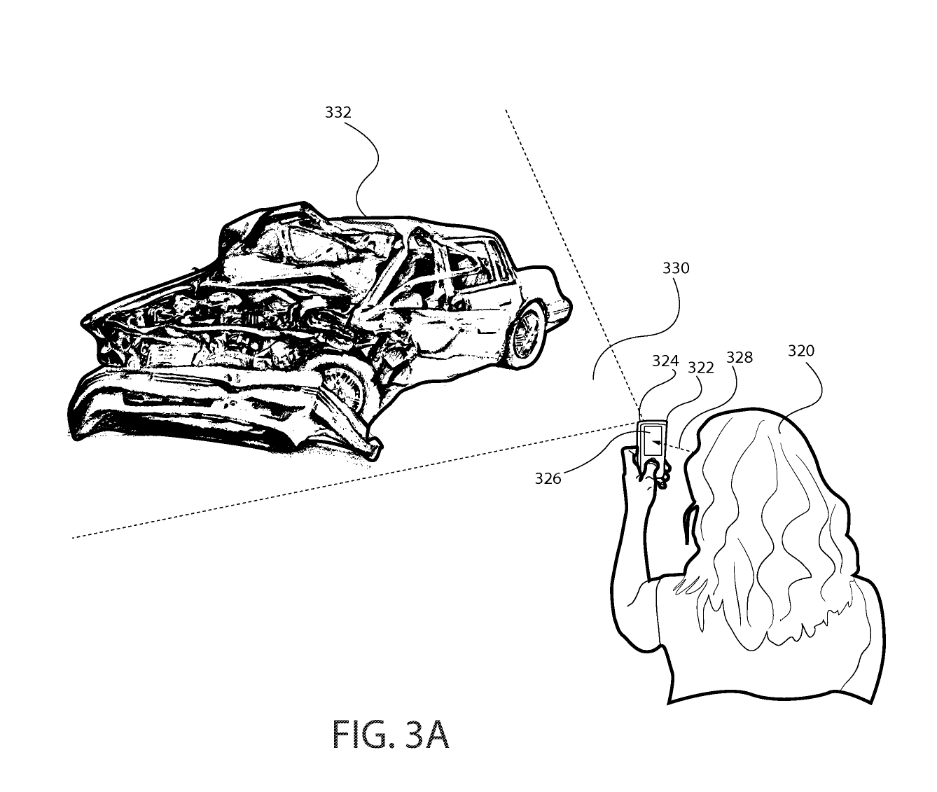

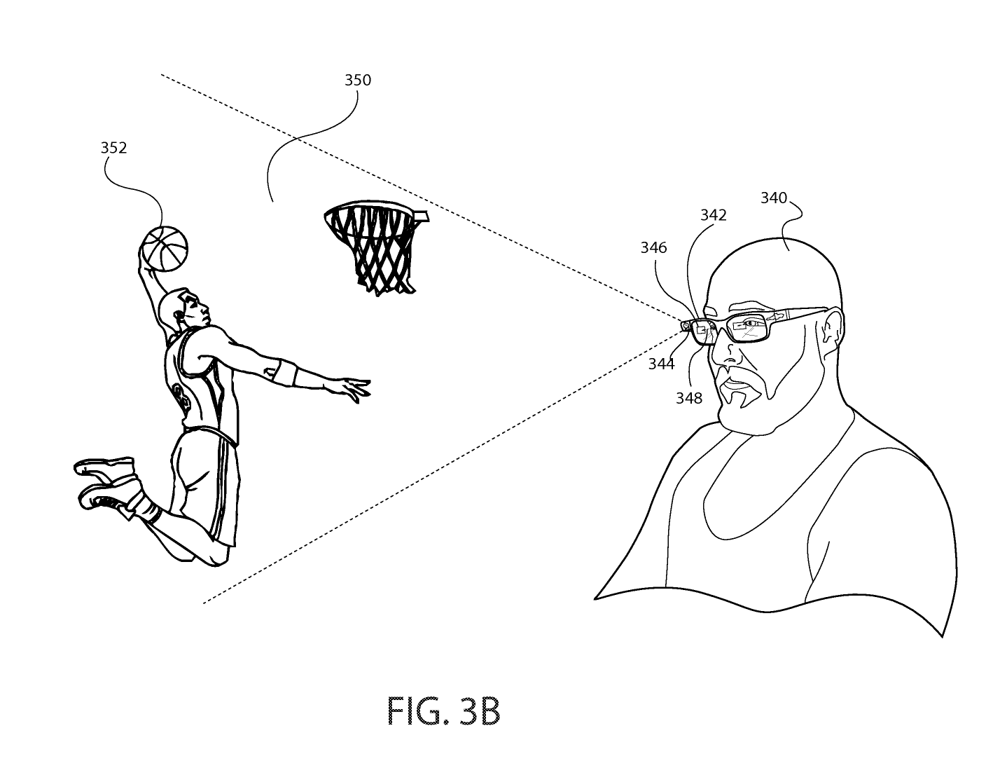

FIGS. 3A-3B are diagrams illustrating capture of visual information indicative of a part of an environment according to at least one example embodiment. The examples of FIGS. 3A-3B are merely examples and do not limit the scope of the claims. For example, apparatus configuration may vary, capture region may vary, direction of user attention may vary, and/or the like.

FIG. 3A is a diagram illustrating capture of visual information indicative of a part of an environment according to at least one example embodiment. In the example of FIG. 3A, user 320 is holding apparatus 322 in the user's hand. As depicted in the example of FIG. 3A, apparatus 322 is a phone apparatus. Apparatus 322 comprises display 326 and camera module 324. In the example of FIG. 3A, capture region 330 of camera module 324 corresponds with a part of the environment that surrounds user 320. As depicted in FIG. 3A, the part of the environment corresponds with vehicle 332. In the example of FIG. 3A, user gaze 328 is directed towards display 326 of apparatus 322. As such, the attention of user 320 fails to be directed towards vehicle 322.

FIG. 3B is a diagram illustrating capture of visual information indicative of a part of an environment according to at least one example embodiment. In the example of FIG. 3B, user 340 is wearing apparatus 342 on the user's head. As depicted in the example of FIG. 3B, apparatus 342 is a head mounted display apparatus. Apparatus 342 comprises display 346 and camera module 344. Display 346 may be a head mounted display, a see through display, a non-see through display, and/or the like. In the example of FIG. 3B, capture region 350 of camera module 344 corresponds with a part of the environment that surrounds user 340. As depicted in FIG. 3B, the part of the environment corresponds with sporting goal 352. In the example of FIG. 3B, user gaze 348 is directed towards display 346 of apparatus 342. As such, the attention of user 340 fails to be directed towards sporting goal 352.

As electronic apparatuses become increasingly prevalent in our society, many users are beginning to utilize such electronic apparatuses manners which facilitate perception of real environments, improve the users' situational awareness, and/or the like. In many circumstances, users may desire to have quick and convenient access to their electronic apparatus, to information associated with the electronic apparatus, and/or the like. In at least one example embodiment, an apparatus is a head mounted display. A head mounted display may be an apparatus worn about a user's head, mounted to the user's head, located near the user's head, and/or the like. The head mounted display may comprise a see through display, a non-see through display, and/or the like. For example, as depicted in FIG. 3B, user 340 is wearing apparatus 342 on the head of user 340. Apparatus 342 comprises display 346 such that user 340 may quickly and conveniently view information associated with apparatus 342.

In many situations, a user of an electronic apparatus may desire to capture visual information that depicts at least a part of the environment surrounding the user in a manner that is intuitive and convenient. For example, the user may desire to take a picture of a landscape, record a video of an event, and/or the like, by way of the user's apparatus. In at least one example embodiment, an apparatus comprises a camera module. The camera module may be a front facing camera module, a rear facing camera module, and/or the like. In at least one example embodiment, a camera module is positioned such that a capture region of the camera module at least partially corresponds with a field of view of a user.

For example, as illustrated in FIG. 3A, apparatus 322 comprises camera module 324. In the example of FIG. 3A, apparatus 320 is a phone apparatus. In the example of FIG. 3A, camera module 324 is positioned such that capture region 330 at least partially corresponds with a field of view of user 320. For example, capture region 330 is oriented in a direction that at least partially corresponds with the direction that user 320 is facing, with a direction that is at least within the peripheral vision of user 320, and/or the like. For example, user 320 may be walking along the street while viewing information displayed on display 326 of apparatus 322. In the example of FIG. 3A, capture region 330 of camera module 324 at least partially corresponds with the part of the environment corresponding with vehicle 332, with at least part of a field of view of user 320, and/or the like.

In another example, as illustrated in FIG. 3B, apparatus 342 comprises camera module 344. In the example of FIG. 3B, apparatus 342 is a head mounted display. In the example of FIG. 3B, camera module 344 is positioned such that capture region 350 at least partially corresponds with a field of view of user 340. For example, capture region 350 is oriented in a direction that at least partially corresponds with the direction that user 340 is facing, with a direction that is at least within the peripheral vision of user 340, and/or the like. For example, user 340 may be attending a sporting match, and may be viewing information displayed on display 346 of apparatus 342. In the example of FIG. 3B, capture region 350 of camera module 344 at least partially corresponds with the part of the environment corresponding with sporting goal 352, with at least part of a field of view of user 340, and/or the like.

In some situations, a user of an electronic apparatus may direct their attention to the electronic apparatus. For example, the user may fixate on a display of the electronic apparatus, may interact with the electronic apparatus, and/or the like. In such situations, the user may incidentally direct their attention away from the environment surrounding the user, at least part of the environment surrounding the user, and/or the like. In such situations, the user may desire to be able to perceive happenings that may have occurred in relation to at least part of the environment surrounding the user while the user's attention was directed away from the part of the environment, directed towards a different part of the environment, and/or the like. For example, the user may desire the user's electronic apparatus to be aware of the direction of the user's attention and to cause performance of certain predetermined functions based on the direction of the user's attention.

In at least one example embodiment, an apparatus determines that a user's attention is directed away from at least part of an environment surrounding the user. In at least one example embodiment, determination that the user's attention is directed away from at least a part of an environment is based, at least in part, on a direction that the user is facing. For example, the apparatus may determine a user orientation of the user. In such an example, the apparatus may determine that the user orientation is inconsistent with the part of the environment being within a field of view of the user. The field of view of the user may be a portion of the environment surrounding the user that the user is able to naturally perceive within the user's vision, peripheral vision, and/or the like.

In some circumstances, it may be desirable to determine a direction of the user's attention based, at least in part, on a direction that the user is gazing, a depth at which the user is gazing, and/or the like. For example, the user gazing in a particular direction may indicate that the user's attention is directed in the particular direction. In another example, the user gazing at the user's electronic apparatus may indicate that the user's attention is directed away from at least part of the environment surrounding the user. In yet another example, the user gazing at a particular part of the environment surrounding the user may indicate that the user's attention is directed away from a different part of the environment.

In at least one example embodiment, an apparatus determines a direction of a user's attention based, at least in part, on a gaze position of the user. In at least one example embodiment, an apparatus determines a gaze position of a user. In such an example embodiment, the apparatus may determine that the gaze position fails to correspond with at least part of the environment surrounding the user based, at least in part, on the gaze position of the user. For example, the determination that the gaze position fails to correspond with the part of the environment may be based, at least in part, on the gaze position corresponding with a different part of the environment. The different part of the environment may be oriented with respect to the user such that the user's attention being directed toward the different part of the environment may preclude the user's attention being directed toward the part of the environment.

As discussed previously, a user of an electronic apparatus may fixate on the electronic apparatus such that the user's attention may be directed away from the environment surrounding the user. In at least one example embodiment, an apparatus determines that a gaze position of a user fails to correspond with at least part of the environment surrounding the user based, at least in part, on the gaze position corresponding with a display. For example, the apparatus may determine that the gaze position of the user corresponds with information being displayed by a display. In such an example, the determination that the gaze position of the user corresponds with information being displayed by the display may be based, at least in part, on gaze tracking, eye movements, and/or the like. For example, the user's gaze shifting back and forth may indicate that the user is reading lines of text displayed on a display, the user's gaze moving in unison with visual information being displayed on the display may indicate that the user is visually tracking the displayed visual information, and/or the like.

As depicted in FIG. 3A, user gaze 328 is directed towards display 326 of apparatus 322. Apparatus 322 may determine that the attention of user 320 is directed away from vehicle 332 based on user gaze 328, a gaze position of user 320 corresponding with a position of display 326, user 320 tracking a visual information displayed on display 326, an orientation of user 320 such that vehicle 332 is not in a field of view of user 320, and/or the like. As depicted in FIG. 3B, user gaze 348 is directed towards display 346 of apparatus 342. Apparatus 342 may determine that the attention of user 340 is directed away from sporting goal 352 based on user gaze 348, a gaze position of user 340 corresponding with a position of display 346, movement of a gaze position of user 340 indicating that user 340 is reading information displayed on display 346, an orientation of user 340 such that sporting goal 352 is not in a field of view of user 340, and/or the like.

In some circumstances, it may be desirable to distinguish between a gaze position of a user and a gaze depth of a user. For example, although a user's gaze position may correspond with at least part of an environment, the user's gaze depth may fail to correspond with the part of the environment. For example, the user may be looking in the general direction of the part of the environment, but may be fixated at a gaze depth that corresponds with a display of an electronic apparatus, with an object that is in the direction of the part of the environment but that may be closer to or further from the user than the part of the environment, and/or the like. In at least one example embodiment, a gaze position comprises a gaze depth. In such an example embodiment, determination that a gaze position fails to correspond with at least part of an environment comprises determination that a gaze depth corresponds with a display. For example, the display may be a head mounted display, and the gaze depth of the user corresponds with the head mounted display. For example, as depicted in FIG. 3B, the gaze position of user 340 may be in the general direction of the part of the environment corresponding with sporting goal 352. However, as depicted, user gaze 348 may be directed toward display 346 of apparatus 342. As such, the gaze depth of user 340 may correspond with display 346, and the user's attention is directed away from sporting goal 352 despite the user's gaze position corresponding with sporting goal 352.

As discussed previously, a user may desire to perceive visual information associated with the environment surrounding the user that the user may not be immediately aware of, may not be directing attention towards, and/or the like. For example, the user may be looking in a direction and may desire to perceive visual information associated with a different direction that may not be within the user's field of view, perceive visual information indicative of a part of the environment in the different direction, and/or the like. In at least one example embodiment, the part of the environment that the user's attention is directed away from is a part of the environment that is within a capture region of a camera module. In at least one example embodiment, an apparatus causes capture of visual information indicative of a part of an environment based, at least in part, on a determination that a user's attention is directed away from the part of the environment. For example, the apparatus may capture the visual information indicative of the part of the environment, may cause a separate apparatus to capture the visual information, and/or the like. The visual information indicative of the part of the environment may be visual information that represents the part of the environment such that a user perceiving the visual information perceives a representation of the part of the environment.

In some circumstances, the user may desire to avoid capturing of visual information indicative of a part of an environment, despite a determination that the user's attention is directed away from the part of the environment. For example, the user may desire to temporarily disable such capture of visual information, may be at a location in which the use of a camera is prohibited, may be attending an event that the user does not desire to have captured for reasons related to privacy, and/or the like. In at least one example embodiment, an apparatus receives information indicative of a user's desire to disable the capture of visual information indicative of a part of an environment. In such an example embodiment, the apparatus may preclude capture of visual information indicative of the part of the environment based, at least in part, on the information indicative of the user's desire to disable the capture of visual information indicative of the part of the environment.

For example, as illustrated in FIG. 3A, the attention of user 320 is directed away from the part of the environment corresponding with vehicle 332 and is directed towards display 326 of apparatus 322, as indicated by user gaze 328. Apparatus 322 may cause capture of visual information indicative of the part of the environment corresponding with vehicle 332. For example, apparatus 322 may cause capture of the part of the environment corresponding with capture region 330 of camera module 324 based, at least in part, on user gaze 328 failing to correspond with vehicle 332, failing to correspond with the part of the environment corresponding with vehicle 332, and/or the like. As depicted in FIG. 3B, the attention of user 340 is directed away from the part of the environment corresponding with sporting goal 352 and towards display 346 of apparatus 342. Apparatus 342 may cause capture of visual information indicative of the part of the environment corresponding with sporting goal 352. For example, apparatus 342 may cause capture of the part of the environment corresponding with capture region 350 of camera module 344 based, at least in part, on user gaze 348 failing to correspond with sporting goal 352, failing to correspond with the part of the environment corresponding with sporting goal 352, and/or the like.

In many circumstances, a user of an electronic apparatus may desire to retain the visual information captured by the camera module. For example, the user may desire to store the visual information for future rendering, may desire to save the visual information such that the user may determine if any interesting event occurred while the user's attention may have been directed elsewhere, and/or the like. In at least one example embodiment, an apparatus causes storage of the visual information as at least part of a video media item. For example, the apparatus may storage the visual information as a video media item, may store the visual information as part of a video media item, may cause a separate apparatus to store the visual information as a video media item, and/or the like. The video media item may be a video, a movie clip, an animated image, and/or the like, and may be of any file type fit for storage of such visual information.

In many situations, once a user redirects their attention toward the part of the environment previously disregarded, the user may desire capture of visual information indicative of the part of the environment to terminate. For example, as the user's attention is now directed toward the part of the environment, the user may not desire to review captured and stored visual information indicative of what the user may have perceived first hand. In such an example, it may be desirable for an apparatus to be aware of a user shifting their attention to the part of the environment, and may be desirable to terminate capture and storage of visual information indicative of the part of the environment based, at least in part, on that shift of attention. In at least one example embodiment, an apparatus determines that a user's attention is directed towards a part of an environment surrounding the user. In such an example, the part of the environment may be a part of the environment that was previously disregarded, the part of the environment that was caused to be captured, the part of the environment that the user's gaze position was determined to be directed away from, and/or the like. In at least one example embodiment, an apparatus causes termination of capture of visual information indicative of at least a part of an environment surrounding a user based, at least in part, on a determination that the user's attention is directed towards the part of the environment.

In the example of FIG. 3A, apparatus 322 may capture visual information indicative of the part of the environment corresponding with vehicle 332 based, at least in part, on the attention of user 320 being directed toward display 326 of apparatus 322. If user gaze 328 is shifted such that the attention of user 320 is directed toward vehicle 332, apparatus 322 may terminate capture of the visual information indicative of the part of the environment corresponding with vehicle 332. For example, user 320 may hear a noise associated with the accident that vehicle 332 incurred and may direct her attention towards vehicle 332. As user 320 may be directly viewing vehicle 332, user 320 may desire termination of capture of visual information indicative of vehicle 332, and may desire to be able to perceive captured and stored visual information that may comprise visual information associated with the cause of the accident.

In the example of FIG. 3B, apparatus 342 may capture visual information indicative of the part of the environment corresponding with sporting goal 352 based, at least in part, on the attention of user 340 being directed toward display 346 of apparatus 342. If user gaze 348 is shifted such that the attention of user 340 is directed toward sporting goal 352, apparatus 342 may terminate capture of the visual information indicative of the part of the environment corresponding with sporting goal 352. For example, user 340 may be at a sporting area and may hear a crowd reaction that indicates that a score associated with sporting goal 352 has been made, and user 340 may direct his attention towards sporting goal 352. As user 340 may be directly viewing sporting goal 352, user 340 may desire termination of capture of visual information indicative of sporting goal 352, and may desire to be able to perceive captured and stored visual information that may comprise visual information associated with the events preceding the score that user 340 may have missed while his attention was directed away from sporting goal 352.

As discussed previously, a user may desire to review video media items that were caused to be stored by the user's electronic apparatus. For example, a user at a football match may have missed an amazing goal made by his favorite football club while the user was checking her email via an electronic apparatus. In such an example, visual information indicative of the goal may have been captured and stored as a video media item. Feeling quite disconnected from the match and the cheering crowd, the user may desire to cause rendering of the video media item such that the user may perceive visual information representative of the goal.

In some circumstances, a user may desire to select a video media item, a part of the video media item, and/or the like, for rendering on a display of the user's electronic apparatus. In at least one example embodiment, an apparatus receives information indicative of a video media item rendering input. In such an example embodiment, the apparatus may cause rendering of at least part of the video media item based, at least in part, on the video media item rendering input. The video media item rendering input may be an input that indicates a video media item, a part of a video media item, etc. that the user desires to be rendered. For example, the user may desire to render the video media item soon after the video media item was stored, at a point later in the day, at some time the next day, and/or the like.

In some circumstances, a user may desire to view a compilation of video media items that were stored through the day, the week, and/or the like. For example, the user may desire to view visual information indicative of parts of the environment surrounding the user that was captured throughout the day while the user's attention was directed away from the respective parts of the environment. In such an example, the user may desire to learn of what events may have occurred while the user was distracted, while the user was viewing a display of the user's electronic apparatus, while the user was paying attention to a different part of the environment, and/or the like. In at least one example embodiment, an apparatus causes rendering of a different video media item that is associated with the video media item based, at least in part, on the video media item rendering input. For example, the apparatus may cause rendering of more than one video media item, more than one part of the video media item, more than one part of more than one video media item, and/or the like. The video media item and the different video media item may be associated based, at least in part, on a day of capture, a time of storage, a location of capture, a week of capture, and/or the like. In at least one example embodiment, an apparatus displays a part of a video media item and a different part of a different video media item based, at least in part, on receipt of a video media item selection input indicating a user's desire to view a compilation of video media items. The part of the video media item and the different part of the different video media item may be portions of the respective video media items that have been identified as significant parts of the respective video media item. For example, rather than viewing the entirety of any video media items that may have been captured over a period of time, the user may desire to view a highlight reel, a daily compilation of potentially significant events, and/or the like.

In order to facilitate perception of compilations that excite the user, interest the user, etc., it may be desirable to identify video media items, parts of video media items, and/or the like via content tags. A content tag may be an identification that identifies the subject matter depicted in the video media item, within the part of the video media item, and/or the like. In at least one example embodiment, an apparatus identifies subject matter depicted in at least a part of a video media item, and causes establishment of an association between the part of the video media item and a content tag indicative of the subject matter. In at least one example embodiment, an apparatus receives information that indicates a content tag to associate with at least part of a video media item, and causes establishment of an association between the part of the video media item and the content tag based, at least in part, on the received information.

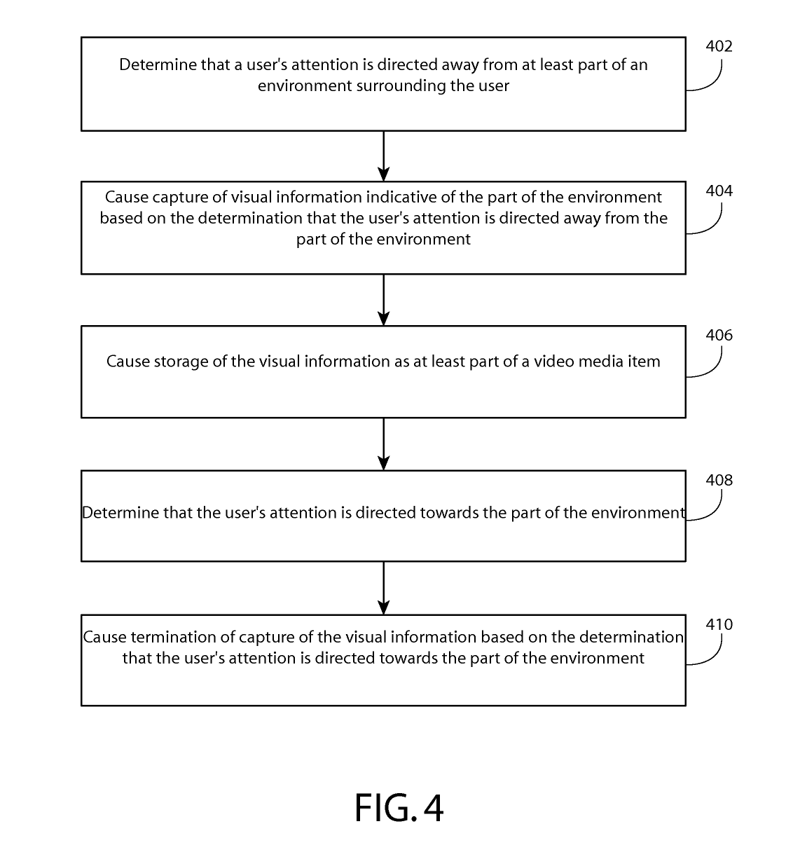

FIG. 4 is a flow diagram illustrating activities associated with causing capture of visual information indicative of a part of an environment according to at least one example embodiment. In at least one example embodiment, there is a set of operations that corresponds with the activities of FIG. 4. An apparatus, for example electronic apparatus 10 of FIG. 1, or a portion thereof, may utilize the set of operations. The apparatus may comprise means, including, for example processor 11 of FIG. 1, for performance of such operations. In an example embodiment, an apparatus, for example electronic apparatus 10 of FIG. 1, is transformed by having memory, for example memory 12 of FIG. 1, comprising computer code configured to, working with a processor, for example processor 11 of FIG. 1, cause the apparatus to perform set of operations of FIG. 4.

At block 402, the apparatus determines that a user's attention is directed away from at least part of an environment surrounding the user. In at least one example embodiment, the part of the environment is within a capture region of a camera module. The determination, the user's attention, the part of the environment, the capture region, and the camera module may be similar as described regarding FIG. 1, FIGS. 2A-2B, and FIGS. 3A-3B.

At block 404, the apparatus causes capture of visual information indicative of the part of the environment based, at least in part, on the determination that the user's attention is directed away from the part of the environment. The capture, the causation of capture, and the visual information may be similar as described regarding FIGS. 3A-3B.

At block 406, the apparatus causes storage of the visual information as at least part of a video media item. The storage, the causation of storage, and the video media item may be similar as described regarding FIGS. 3A-3B.

At block 408, the apparatus determines that the user's attention is directed towards the part of the environment. The determination and the user's attention may be similar as described regarding FIGS. 3A-3B.

At block 410, the apparatus causes termination of capture of the visual information based, at least in part, on the determination that the user's attention is directed towards the part of the environment. The termination of capture and the causation of termination of capture may be similar as described regarding FIGS. 3A-3B.

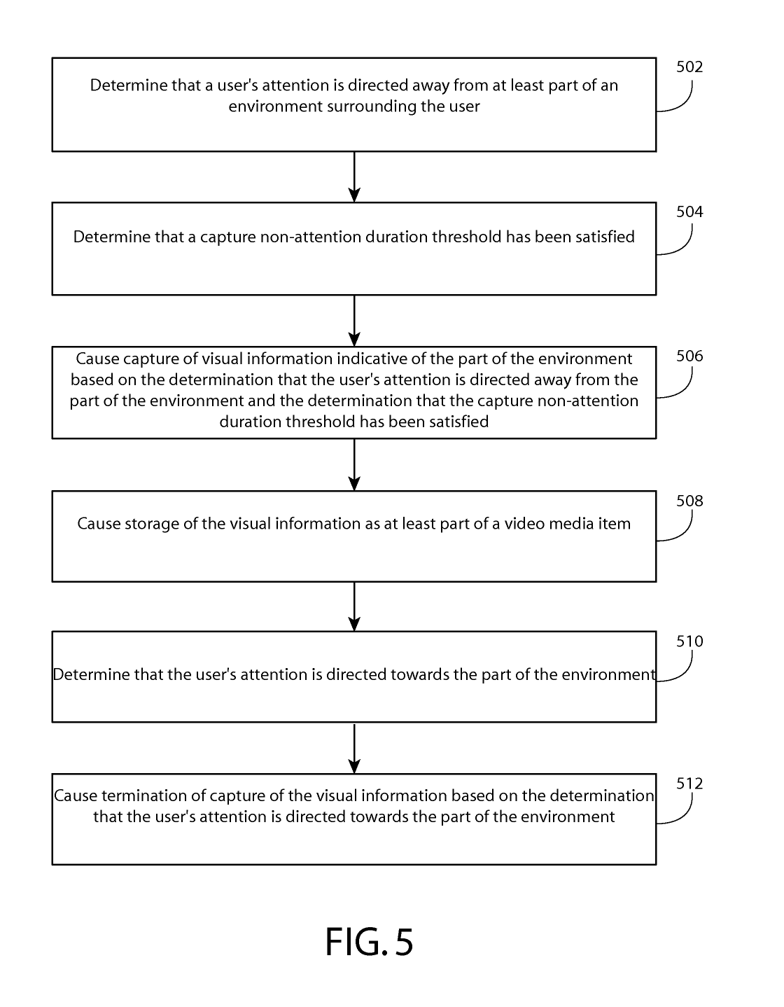

FIG. 5 is a flow diagram illustrating activities associated with causing capture of visual information indicative of a part of an environment based on satisfaction of a capture non-attention duration threshold according to at least one example embodiment. In at least one example embodiment, there is a set of operations that corresponds with the activities of FIG. 5. An apparatus, for example electronic apparatus 10 of FIG. 1, or a portion thereof, may utilize the set of operations. The apparatus may comprise means, including, for example processor 11 of FIG. 1, for performance of such operations. In an example embodiment, an apparatus, for example electronic apparatus 10 of FIG. 1, is transformed by having memory, for example memory 12 of FIG. 1, comprising computer code configured to, working with a processor, for example processor 11 of FIG. 1, cause the apparatus to perform set of operations of FIG. 5.

As discussed previously, in some circumstances, it may be desirable to cause capturing of visual information indicative of at least part of an environment surrounding a user. In order to avoid capturing of visual information indicative of the part of the environment every time a user blinks, glances away for a moment, and/or the like, it may be desirable to cause capture of visual information once the user's attention has been directed away from a predetermined amount of time.

In at least one example embodiment, an apparatus determines that a capture non-attention duration threshold has been satisfied. In such an example embodiment, causation of capture of visual information may be based, at least in part, on the determination that the capture non-attention duration threshold has been satisfied. The capture non-attention duration threshold may be an amount of time that the user's attention has been directed away from the part of the environment after which it may be desirable to cause capture of the visual information indicative of the part of the environment. In at least one example embodiment, determination that a non-attention duration threshold has been satisfied comprises determination that an amount of time greater than or equal to the non-attention duration threshold has elapsed since the determination that the user's attention is directed away from the part of the environment.

At block 502, the apparatus determines that a user's attention is directed away from at least part of an environment surrounding the user. In at least one example embodiment, the part of the environment is within a capture region of a camera module. The determination, the user's attention, the part of the environment, the capture region, and the camera module may be similar as described regarding FIG. 1, FIGS. 2A-2B, and FIGS. 3A-3B.

At block 504, the apparatus determines that a capture non-attention duration threshold has been satisfied.

At block 506, the apparatus the apparatus causes capture of visual information indicative of the part of the environment based, at least in part, on the determination that the user's attention is directed away from the part of the environment and the determination that the capture non-attention duration threshold has been satisfied. The capture, the causation of capture, and the visual information may be similar as described regarding FIGS. 3A-3B.

At block 508, the apparatus causes storage of the visual information as at least part of a video media item. The storage, the causation of storage, and the video media item may be similar as described regarding FIGS. 3A-3B.

At block 510, the apparatus determines that the user's attention is directed towards the part of the environment. The determination and the user's attention may be similar as described regarding FIGS. 3A-3B.

At block 512, the apparatus causes termination of capture of the visual information based, at least in part, on the determination that the user's attention is directed towards the part of the environment. The termination of capture and the causation of termination of capture may be similar as described regarding FIGS. 3A-3B.

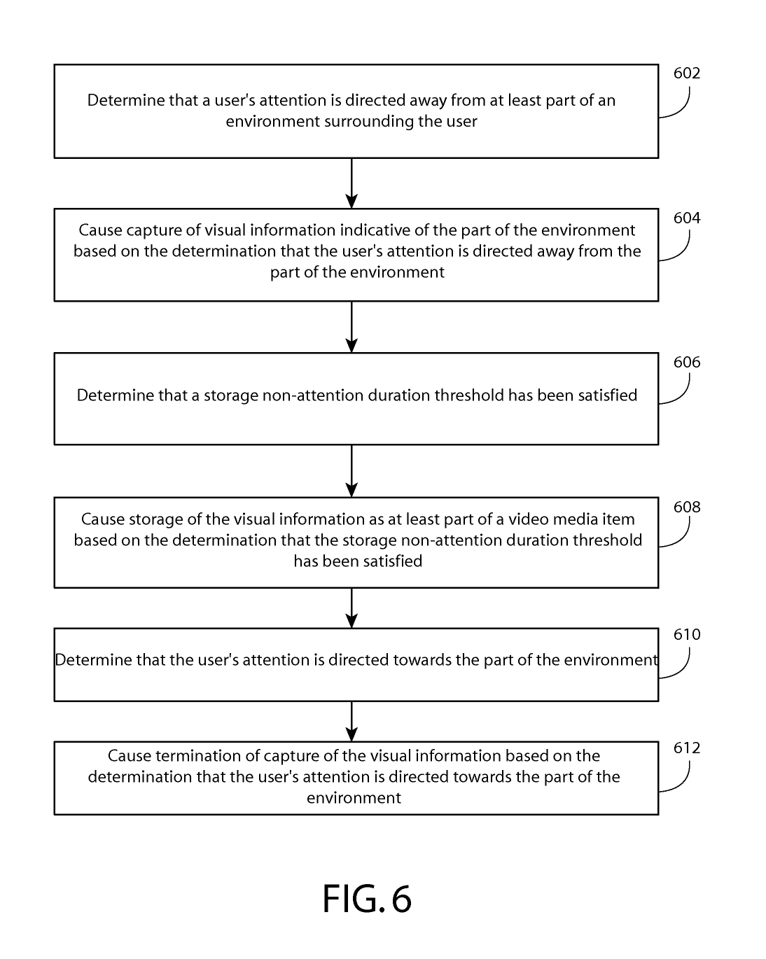

FIG. 6 is a flow diagram illustrating activities associated with causing storage of visual information indicative of a part of an environment based on satisfaction of a storage non-attention duration threshold according to at least one example embodiment. In at least one example embodiment, there is a set of operations that corresponds with the activities of FIG. 6. An apparatus, for example electronic apparatus 10 of FIG. 1, or a portion thereof, may utilize the set of operations. The apparatus may comprise means, including, for example processor 11 of FIG. 1, for performance of such operations. In an example embodiment, an apparatus, for example electronic apparatus 10 of FIG. 1, is transformed by having memory, for example memory 12 of FIG. 1, comprising computer code configured to, working with a processor, for example processor 11 of FIG. 1, cause the apparatus to perform set of operations of FIG. 6.

As discussed previously, in some circumstances, it may be desirable to cause storage of visual information indicative of at least part of an environment surrounding a user as at least part of a video media item. In order to avoid storing of video media items every time a user blinks, glances away for a moment, and/or the like, it may be desirable to cause storage of the part of the video media item once the user's attention has been directed away from a predetermined amount of time. For example, it may be desirable to determine that the user's attention has been directed away from the part of the environment for at least the predetermined amount of time in order to reduce consumption of a limited storage capacity, facilitate availability of storage capacity for future video media items, and/or the like.

In at least one example embodiment, an apparatus determines that a storage non-attention duration threshold has been satisfied. In such an example embodiment, causation of storage of the visual information may be based, at least in part, on the determination that the storage non-attention duration threshold has been satisfied. The storage non-attention duration threshold may be an amount of time that the user's attention has been directed away from the part of the environment after which it may be desirable to cause storage of the visual information as the part of the video media item. In at least one example embodiment, determination that a non-attention duration threshold has been satisfied comprises determination that an amount of time greater than or equal to the non-attention duration threshold has elapsed since the determination that the user's attention is directed away from the part of the environment.

At block 602, the apparatus determines that a user's attention is directed away from at least part of an environment surrounding the user. In at least one example embodiment, the part of the environment is within a capture region of a camera module. The determination, the user's attention, the part of the environment, the capture region, and the camera module may be similar as described regarding FIG. 1, FIGS. 2A-2B, and FIGS. 3A-3B.

At block 604, the apparatus causes capture of visual information indicative of the part of the environment based, at least in part, on the determination that the user's attention is directed away from the part of the environment. The capture, the causation of capture, and the visual information may be similar as described regarding FIGS. 3A-3B.

At block 606, the apparatus determines that a storage non-attention duration threshold has been satisfied.

At block 608, the apparatus causes storage of the visual information as at least part of a video media item based, at least in part, on the determination that the storage non-attention duration threshold has been satisfied. The storage, the causation of storage, and the video media item may be similar as described regarding FIGS. 3A-3B.

At block 610, the apparatus determines that the user's attention is directed towards the part of the environment. The determination and the user's attention may be similar as described regarding FIGS. 3A-3B.

At block 612, the apparatus causes termination of capture of the visual information based, at least in part, on the determination that the user's attention is directed towards the part of the environment. The termination of capture and the causation of termination of capture may be similar as described regarding FIGS. 3A-3B.

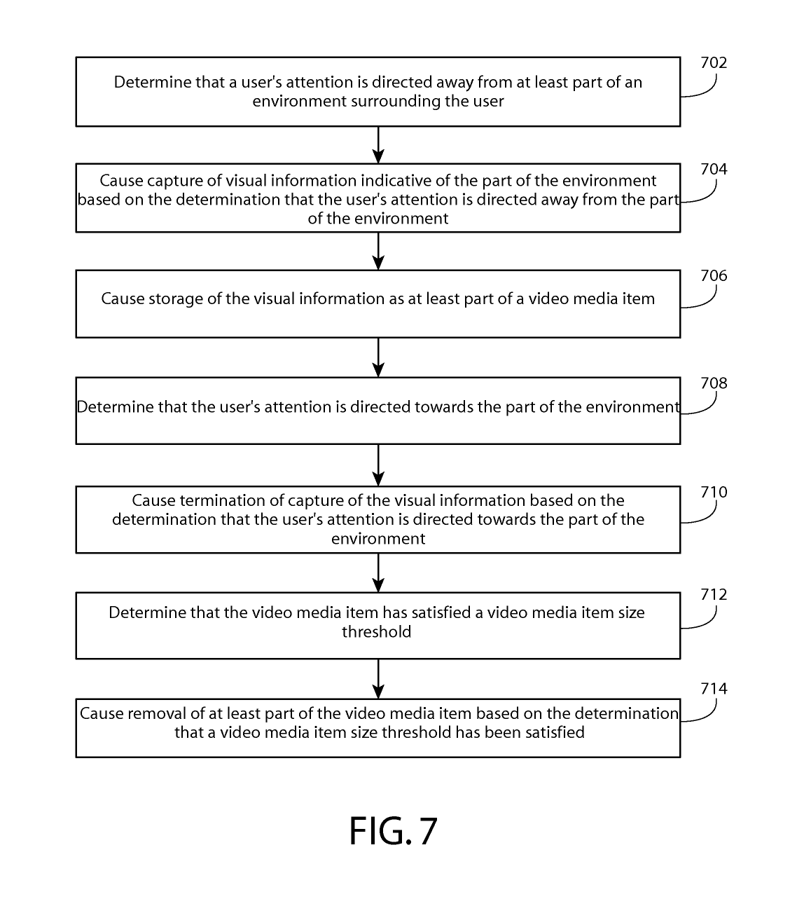

FIG. 7 is a flow diagram illustrating activities associated with causing removal of at least a part of a video media item based on satisfaction of a video media item size threshold according to at least one example embodiment. In at least one example embodiment, there is a set of operations that corresponds with the activities of FIG. 7. An apparatus, for example electronic apparatus 10 of FIG. 1, or a portion thereof, may utilize the set of operations. The apparatus may comprise means, including, for example processor 11 of FIG. 1, for performance of such operations. In an example embodiment, an apparatus, for example electronic apparatus 10 of FIG. 1, is transformed by having memory, for example memory 12 of FIG. 1, comprising computer code configured to, working with a processor, for example processor 11 of FIG. 1, cause the apparatus to perform set of operations of FIG. 7.

In some circumstances, it may be desirable to limit the amount of video media items stored by an electronic apparatus. For example, the electronic apparatus may comprise memory with a limited storage capacity, the user may desire ensure that file space exists to store files in the memory in addition to the video media items, and/or the like. As such, it may be desirable to maintain a predetermined amount of video media items, a predetermined file size limit, and/or the like. In at least one example embodiment, an apparatus determines that a video media item has satisfied a video media item size threshold. The video media item size threshold may be a temporal, a disk utilization size of the video media item beyond which the part of the video media item is to be removed, and/or the like. In one or more example embodiments, an apparatus causes removal of at least part of a video media item based, at least in part, on the determination that the video media item size threshold has been satisfied. The removal of the part of the video media item may be a first-in-first-out removal, a removal based on manual selection of at least part of the video media item, and/or the like. Removal of the part of the video media item may increase the amount of file storage space available for storage of video media items such that additional video media items may be stored.

At block 702, the apparatus determines that a user's attention is directed away from at least part of an environment surrounding the user. In at least one example embodiment, the part of the environment is within a capture region of a camera module. The determination, the user's attention, the part of the environment, the capture region, and the camera module may be similar as described regarding FIG. 1, FIGS. 2A-2B, and FIGS. 3A-3B.

At block 704, the apparatus causes capture of visual information indicative of the part of the environment based, at least in part, on the determination that the user's attention is directed away from the part of the environment. The capture, the causation of capture, and the visual information may be similar as described regarding FIGS. 3A-3B.

At block 706, the apparatus causes storage of the visual information as at least part of a video media item. The storage, the causation of storage, and the video media item may be similar as described regarding FIGS. 3A-3B.

At block 708, the apparatus determines that the user's attention is directed towards the part of the environment. The determination and the user's attention may be similar as described regarding FIGS. 3A-3B.

At block 710, the apparatus causes termination of capture of the visual information based, at least in part, on the determination that the user's attention is directed towards the part of the environment. The termination of capture and the causation of termination of capture may be similar as described regarding FIGS. 3A-3B.

At block 712, the apparatus determination that the video media item has satisfied a video media item size threshold.

At block 714, the apparatus causes removal of at least part of the video media item based, at least in part, on the determination that the video media item size threshold has been satisfied.

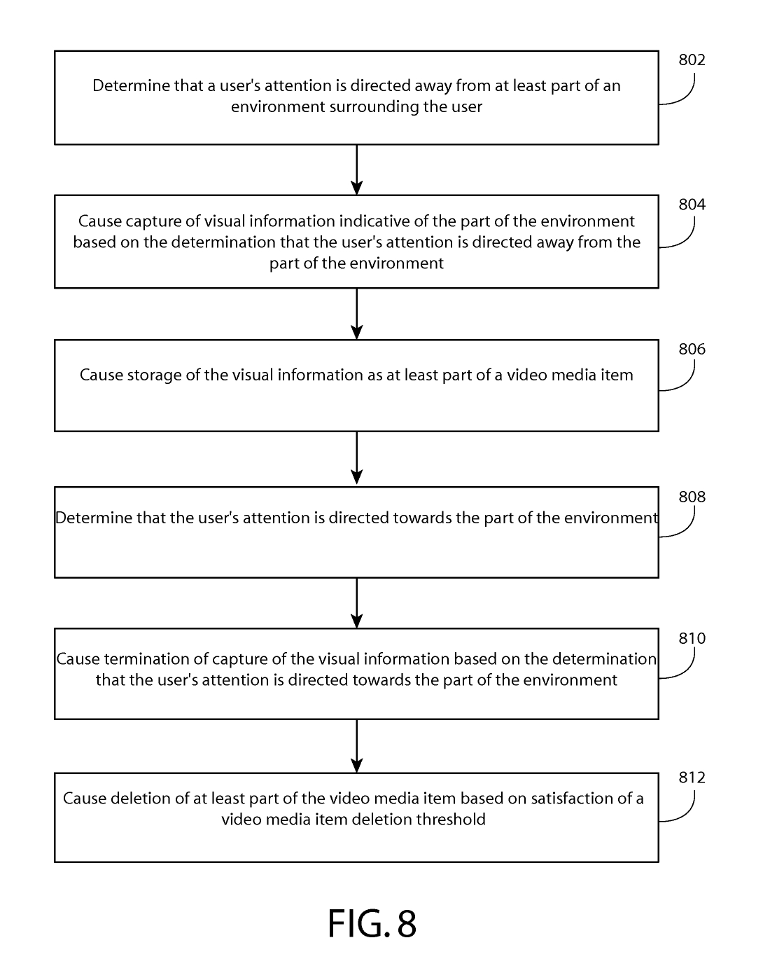

FIG. 8 is a flow diagram illustrating activities associated with causing deletion of at least a part of a video media item based on satisfaction of a video media item deletion according to at least one example embodiment. In at least one example embodiment, there is a set of operations that corresponds with the activities of FIG. 8. An apparatus, for example electronic apparatus 10 of FIG. 1, or a portion thereof, may utilize the set of operations. The apparatus may comprise means, including, for example processor 11 of FIG. 1, for performance of such operations. In an example embodiment, an apparatus, for example electronic apparatus 10 of FIG. 1, is transformed by having memory, for example memory 12 of FIG. 1, comprising computer code configured to, working with a processor, for example processor 11 of FIG. 1, cause the apparatus to perform set of operations of FIG. 8.

In some circumstances, it may be desirable to purge, at least a portion of, the video media items stored by an electronic apparatus. For example, a user may desire to review video media items stored recently, but may not desire to review video media items stored several days prior. In another example, the electronic apparatus may comprise memory with a limited storage capacity, the user may desire ensure that file space exists to store files in the memory in addition to the video media items, and/or the like. As such, it may be desirable to maintain a predetermined amount of video media items, a predetermined file size limit, purge video media items that were stored prior to a predetermined time, remove video media items that have been stored for a predetermined duration, and/or the like. In at least one example embodiment, an apparatus causes deletion of at least part of the video media item. For example, the apparatus may delete the part of the video media item from memory, cause deletion of the part of the video media item stored in a repository, cause deletion of the part of the video media item stored via a separate apparatus, and/or the like. In at least one example embodiment, an apparatus causes deletion of a part of a video media item is based, at least in part, on satisfaction of a video media item deletion threshold. The video media item deletion threshold may be a duration after which a video media item is to be deleted. For example, the video media item deletion threshold may be twenty-four hours, a time that is less than an hour, five minutes, and/or the like. In at least one example embodiment, an apparatus causes deletion of at least part of a video media item based, at least in part, on receipt of information that indicates that a user desires that the part of the video media item be deleted. For example, the user may determine that she does not desire to review the part of the video media item, and may desire that the part of the video media item be deleted such that file storage capacity is made available for different video media items. In such an example, the apparatus may receive information indicative of such a desire and cause deletion of the part of the video media item.

At block 802, the apparatus determines that a user's attention is directed away from at least part of an environment surrounding the user. In at least one example embodiment, the part of the environment is within a capture region of a camera module. The determination, the user's attention, the part of the environment, the capture region, and the camera module may be similar as described regarding FIG. 1, FIGS. 2A-2B, and FIGS. 3A-3B.

At block 804, the apparatus causes capture of visual information indicative of the part of the environment based, at least in part, on the determination that the user's attention is directed away from the part of the environment. The capture, the causation of capture, and the visual information may be similar as described regarding FIGS. 3A-3B.

At block 806, the apparatus causes storage of the visual information as at least part of a video media item. The storage, the causation of storage, and the video media item may be similar as described regarding FIGS. 3A-3B.

At block 808, the apparatus determines that the user's attention is directed towards the part of the environment. The determination and the user's attention may be similar as described regarding FIGS. 3A-3B.

At block 810, the apparatus causes termination of capture of the visual information based, at least in part, on the determination that the user's attention is directed towards the part of the environment. The termination of capture and the causation of termination of capture may be similar as described regarding FIGS. 3A-3B.

At block 812, the apparatus causes deletion of the video media item based, at least in part, on satisfaction of a video media item deletion threshold.

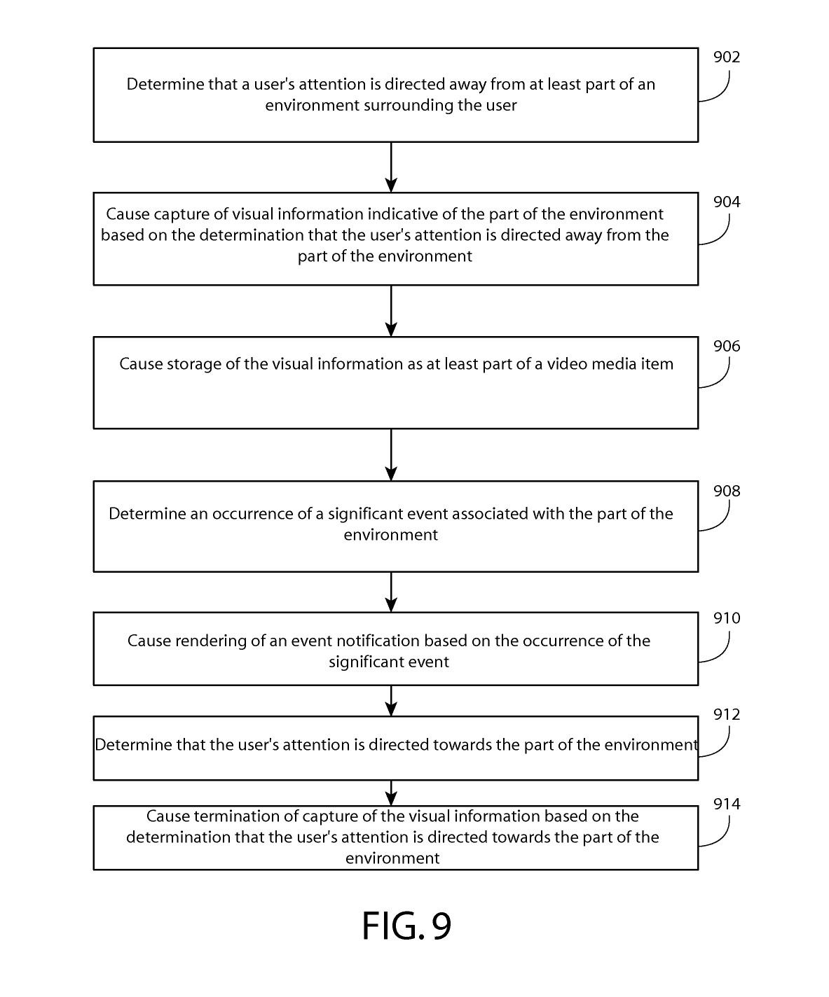

FIG. 9 is a flow diagram illustrating activities associated with causing rendering of an event notification based on occurrence of a significant event according to at least one example embodiment. In at least one example embodiment, there is a set of operations that corresponds with the activities of FIG. 9. An apparatus, for example electronic apparatus 10 of FIG. 1, or a portion thereof, may utilize the set of operations. The apparatus may comprise means, including, for example processor 11 of FIG. 1, for performance of such operations. In an example embodiment, an apparatus, for example electronic apparatus 10 of FIG. 1, is transformed by having memory, for example memory 12 of FIG. 1, comprising computer code configured to, working with a processor, for example processor 11 of FIG. 1, cause the apparatus to perform set of operations of FIG. 9.

In many circumstances, a user of an electronic apparatus may desire to be alerted of events that may be occurring in relation to the environment surrounding the user. For example, the user may desire to perceive certain events first hand rather than perceive a video media item comprising visual information indicative of the events at a later time. For example, the user's attention may be directed away from at least a part of the environment surrounding the user. In such an example, an interesting, important, etc. event may occur in relation to the part of the environment while the user is not paying attention to the part of the environment. In such an example, the user may desire to be prompted to shift her attention to the part of the environment such that the user may perceive the event. In at least one example embodiment, an apparatus determines occurrence of a significant event associated with the part of the environment. The significant event may be an event that the user may desire to be aware of. In at least one example embodiment, an apparatus causes rendering of an event notification based, at least in part, on an occurrence of s significant event. The event notification may comprise information indicative of the event notification such that rendering of the event notification notifies the user of the occurrence of the significant event, may draw the user's attention to the part of the environment, may prompt the user to shift her attention to the part of the environment, and/or the like.

As depicted in the example of FIG. 3A, the attention of user 320 is directed away from vehicle 332. Vehicle 332 is involved in a collision while user gaze 328 is directed towards display 326 of apparatus 322. Apparatus 322 may determine occurrence of a significant event, for example the collision of vehicle 332 with another vehicle, based, at least in part, on auditory cues, visual cues, and/or the like. Apparatus 322 may cause rendering of an event notification associated with the collision such that user 320 is made aware of the collision, is prompted to shift her attention to the part of the environment corresponding with vehicle 332, and/or the like.

As depicted in the example of FIG. 3B, the attention of user 340 is directed away from sporting goal 352. A goal associated with sporting goal 352 may be made while user gaze 348 is directed towards display 346 of apparatus 342. Apparatus 342 may determine occurrence of a significant event, for example the goal associated with sporting goal 352, based, at least in part, on auditory cues, visual cues, and/or the like. Apparatus 342 may cause rendering of an event notification associated with the goal such that user 340 is made aware of the goal, is prompted to shift her attention to the part of the environment corresponding with sporting goal 352, and/or the like.

At block 902, the apparatus determines that a user's attention is directed away from at least part of an environment surrounding the user. In at least one example embodiment, the part of the environment is within a capture region of a camera module. The determination, the user's attention, the part of the environment, the capture region, and the camera module may be similar as described regarding FIG. 1, FIGS. 2A-2B, and FIGS. 3A-3B.

At block 904, the apparatus causes capture of visual information indicative of the part of the environment based, at least in part, on the determination that the user's attention is directed away from the part of the environment. The capture, the causation of capture, and the visual information may be similar as described regarding FIGS. 3A-3B.

At block 906, the apparatus causes storage of the visual information as at least part of a video media item. The storage, the causation of storage, and the video media item may be similar as described regarding FIGS. 3A-3B.

At block 908, the apparatus determines an occurrence of a significant event associated with the part of the environment.

At block 910, the apparatus causes rendering of an event notification based, at least in part, on the occurrence of the significant event.

At block 912, the apparatus determines that the user's attention is directed towards the part of the environment. The determination and the user's attention may be similar as described regarding FIGS. 3A-3B.

At block 914, the apparatus causes termination of capture of the visual information based, at least in part, on the determination that the user's attention is directed towards the part of the environment. The termination of capture and the causation of termination of capture may be similar as described regarding FIGS. 3A-3B.

Embodiments of the invention may be implemented in software, hardware, application logic or a combination of software, hardware, and application logic. The software, application logic and/or hardware may reside on the apparatus, a separate device, or a plurality of separate devices. If desired, part of the software, application logic and/or hardware may reside on the apparatus, part of the software, application logic and/or hardware may reside on a separate device, and part of the software, application logic and/or hardware may reside on a plurality of separate devices. In an example embodiment, the application logic, software or an instruction set is maintained on any one of various conventional computer-readable media.

If desired, the different functions discussed herein may be performed in a different order and/or concurrently with each other. For example, block 908 of FIG. 9 may be performed before block 904 of FIG. 9. Furthermore, if desired, one or more of the above-described functions may be optional or may be combined. For example, block 406 of FIG. 4 may be optional and/or combined with block 404 of FIG. 4.

Although various aspects of the invention are set out in the independent claims, other aspects of the invention comprise other combinations of features from the described embodiments and/or the dependent claims with the features of the independent claims, and not solely the combinations explicitly set out in the claims.

It is also noted herein that while the above describes example embodiments of the invention, these descriptions should not be viewed in a limiting sense. Rather, there are variations and modifications which may be made without departing from the scope of the present invention as defined in the appended claims.

What is claimed is:

1. An apparatus, comprising:
at least one processor;
at least one memory including computer program code, the memory and the computer program code configured to, working with the processor, cause the apparatus to perform at least the following:
determination that a user's attention is directed away from at least part of an environment surrounding the user, the part of the environment being within a capture region of a camera module;
causation of capture of visual information indicative of the part of the environment based, at least in part, on the determination that the user's attention is directed away from the part of the environment;
causation of storage of the visual information as at least part of a video media item;
determination that the user's attention is directed towards the part of the environment; and
causation of termination of capture of the visual information based, at least in part, on the determination that the user's attention is directed towards the part of the environment.

2. The apparatus of claim 1, wherein the determination that the user's attention is directed away from the part of the environment comprises determination of a gaze position of the user, and determination that the gaze position fails to correspond with the part of the environment.

3. The apparatus of claim 1, wherein the memory includes computer program code configured to, working with the processor, cause the apparatus to perform determination that a capture non-attention duration threshold has been satisfied, and wherein the causation of capture of the visual information is further based, at least in part, on the determination that the capture non-attention duration threshold has been satisfied.

4. The apparatus of claim 1, wherein the memory includes computer program code configured to, working with the processor, cause the apparatus to perform determination that a storage non-attention duration threshold has been satisfied, and wherein the causation of storage of the visual information is further based, at least in part, on the determination that the storage non-attention duration threshold has been satisfied.

5. The apparatus of claim 1, wherein the memory includes computer program code configured to, working with the processor, cause the apparatus to perform:
determination that the video media item has satisfied a video media item size threshold; and
causation of removal of at least part of the video media item based, at least in part, on the determination that the video media item size threshold has been satisfied.

6. The apparatus of claim 1, wherein the memory includes computer program code configured to, working with the processor, cause the apparatus to perform causation of deletion of at least part of the video media item.

7. The apparatus of claim 1, wherein the memory includes computer program code configured to, working with the processor, cause the apparatus to perform:
receipt of information indicative of a video media item rendering input; and
causation of rendering of at least part of the video media item based, at least in part, on the video media item rendering input.

8. The apparatus of claim 1, wherein the memory includes computer program code configured to, working with the processor, cause the apparatus to perform:
determination of an occurrence of a significant event associated with the part of the environment; and
causation of rendering of an event notification based, at least in part, on the occurrence of the significant event.

9. The apparatus of claim 1, wherein the apparatus comprises a display.

10. A method comprising:
determining that a user's attention is directed away from at least part of an environment surrounding the user, the part of the environment being within a capture region of a camera module;
causing capture of visual information indicative of the part of the environment based, at least in part, on the determination that the user's attention is directed away from the part of the environment;
causing storage of the visual information as at least part of a video media item;
determining that the user's attention is directed towards the part of the environment; and
causing termination of capture of the visual information based, at least in part, on the determination that the user's attention is directed towards the part of the environment.

11. The method of claim 10, further comprising determining that a capture non-attention duration threshold has been satisfied, and wherein the causation of capture of the visual information is further based, at least in part, on the determination that the capture non-attention duration threshold has been satisfied.

12. The method of claim 10, further comprising determining that a storage non-attention duration threshold has been satisfied, and wherein the causation of storage of the visual information is further based, at least in part, on the determination that the storage non-attention duration threshold has been satisfied.

13. The method of claim 10, further comprising:
determining that the video media item has satisfied a video media item size threshold; and
causing removal of at least part of the video media item based, at least in part, on the determination that the video media item size threshold has been satisfied.

14. The method of claim 10, further comprising causing deletion of at least part of the video media item.

15. The method of claim 10, further comprising:
receiving information indicative of a video media item rendering input; and
causing rendering of at least part of the video media item based, at least in part, on the video media item rendering input.

16. The method of claim 10, further comprising:
determining an occurrence of a significant event associated with the part of the environment; and
causing rendering of an event notification based, at least in part, on the occurrence of the significant event.

17. At least one computer-readable medium encoded with instructions that, when executed by a processor, perform:
determining that a user's attention is directed away from at least part of an environment surrounding the user, the part of the environment being within a capture region of a camera module;
causing capture of visual information indicative of the part of the environment based, at least in part, on the determination that the user's attention is directed away from the part of the environment;
causing storage of the visual information as at least part of a video media item;
determining that the user's attention is directed towards the part of the environment; and
causing termination of capture of the visual information based, at least in part, on the determination that the user's attention is directed towards the part of the environment.

18. The medium of claim 17, further encoded with instructions that, when executed by a processor, perform:
determining that the video media item has satisfied a video media item size threshold; and
causing removal of at least part of the video media item based, at least in part, on the determination that the video media item size threshold has been satisfied.

19. The medium of claim 17, further encoded with instructions that, when executed by a processor, perform:
receiving information indicative of a video media item rendering input; and
causing rendering of at least part of the video media item based, at least in part, on the video media item rendering input.

20. The medium of claim 17, further encoded with instructions that, when executed by a processor, perform:
determining an occurrence of a significant event associated with the part of the environment; and
causing rendering of an event notification based, at least in part, on the occurrence of the significant event.
